(19) United States
(12) Patent Application Publication
(10) Pub. No.: US 2005/0236973 A1
(43) Pub. Date: Oct. 27, 2005

(54) Electroluminescent assembly

(76) Inventors: Karl Leo, Dresden (DE); Jan Blochwitz-Nimoth, Dresden (DE); Martin Pfeiffer, Dresden (DE)

Correspondence Address: BAKER & BOTTS, 30 ROCKEFELLER PLAZA, NEW YORK, NY, 10112, US

(21) Appl. No.: 10/488,586

(22) PCT Filed: Dec. 19, 2003
(86) PCT No.: PCT/DE03/04188

§ 371 Date: Dec. 6, 2004

(30) Foreign Application Priority Data
Dec. 20, 2002 (DE) 102 61 609.4

(51) Int. Cl. H05B 33/00

(52) U.S. Cl. 313/504; 313/506

(57) ABSTRACT

The invention relates to a light-emitting apparatus consisting of a conductor plate and a light-emitting component having organic layers. The component comprises at least one charge carrier transport layer for electrons and/or holes from an organic material (5, 9, 25, 29, 45, 49) and a light-emitting layer of an organic material (7, 27, 47), and is characterized in that the organic sequence of layers is applied to a conductor plate as substrate and provided with at least one doped transport layer to improve electron and/or hole injection. In addition, layers to improve substrate-side electron or hole injection (3, 23, 43) and smoothing layers (4, 24) may be used.

The invention relates to a light-emitting apparatus consisting of a conductor plate and a light-emitting component having organic layers, in particular an organic light-emitting diode according to the generic clause of claim 1.

Organic light-emitting diodes have been promising candidates for the realization of large-area displays since the demonstration of low working voltages by Tang et al. 1987 [C. W. Tang et al., Appl. Phys. Lett. 51 (1987, no. 12), 913]. They consist of a sequence of thin (typically 1 nm to 1μ) layers of organic materials preferably vapor-deposited under vacuum or centrifuged on in their polymer form or printed. After electrical contacting by metal layers, they form manifold electronic or opto-electronic components such as e.g. diodes, light-emitting diodes, photodiodes and transistors whose properties compete with the established components based on inorganic layers. In the case of organic light-emitting diodes (OLEDs), the injection of charge carriers (electrons from one side, holes from the other side) from the contacts into the organic layers in between due to an external applied voltage, the subsequent formation of excitons (electron-hole pairs) in an active zone, and the radiant recombination of said excitons, generate light and emit it from the light-emitting diode.

The advantage of such components on an organic basis over conventional components on an inorganic basis (semiconductors such as silicon, gallium arsenide) consists in that it is possible to produce very large-area display elements (screens, Bildschirme). The organic starting materials are relatively economical compared to the inorganic materials (low outlay of materials and energy). Furthermore, these materials, owing to their low process temperature compared to inorganic materials, can be applied to flexible substrates, opening up an entire series of novel applications in the display and illuminating arts.

Conventional components represent an arrangement of one or more of the following layers:
a) Carrier, substrate
b) Base electrode, hole-injecting (plus pole), transparent
c) Hole-injecting layer
d) Hole-transporting layer (HTL)
e) Light-emitting layer (EL)
f) Electron-transporting layer (ETL)
g) Electron-injecting layer
h) Cover electrode, usually a metal with low work of emergence, electron-injecting (minus pole)
i) Capsule, to shut out environmental influences
   This is the most general case; as a rule, some layers are omitted (other than b, e and h), or else one layer combines several properties in itself.

The emergence of light takes place in the sequence of layers described through the transparent base electrode and the substrate, while the cover electrode consists of non-transparent metal layers. Current materials for hole injection are almost exclusively indium-tin oxide (ITO) as injection contact for holes (a transparent degenerate semiconductor). For electron injection, use is made of materials such as aluminum (Al), Al in combination with a thin layer of lithium fluoride (LiF), magnesium (Mg), calcium (Ca) or a mixed layer of Mg and silver (Ag).

For many applications, it is desirable that the emission of light take place not towards the substrate but through the cover electrode. Especially important as examples of this are displays or other luminescent elements based on organic light-emitting diodes that are built up on non-transparent substrates such as conductor plates for example. Since many applications combine several functionalities, like for example electronic components, keyboards and display functions, it would be extraordinarily advantageous if all of these could be integrated on the conductor plate with as little outlay as possible. Conductor plates could be equipped fully automatic, signifying enormous savings of cost in the production of a large-area integrated display. By conductor plates in the sense of the present invention, then, we mean any devices or substrates into which other functional components than the OLEDs can be integrated in simple manner (e.g. by bonding, soldering, adhesion, plug-in connection). These may be conventional conductor plates, or else ceramic conductor-plate-like substrates on one side of which the OLEDs and on the other side, electrically connected to the OLEDs, various electrical function elements are located. The conductor-plate-like substrates may be of flat or else arched conformation.

The emission that this requires on the part of the cover electrode can be achieved for the sequence of organic layers described above (cover electrode as cathode) in that a very thin conventional metal electrode is applied. Since this at a thickness affording sufficiently high transmission will not yet achieve any high transverse conductivity, a transparent contact material must be applied in addition, either ITO or zinc-doped indium oxide (e.g. U.S. Pat. No. 5,703,436 (S. R. Forrest et al.) filed 6 Mar. 1996; U.S. Pat. No. 5,757,026 (S. R. Forrest et al.) filed 15 Apr. 1996; U.S. Pat. No. 5,969,474 (M. Arai) filed 24 Oct. 1997). Other known realizations of this structure provide an organic interlayer to improve electron ignition (e.g. G. Parthasarathy et al., Appl. Phys. Lett. 72 (1997), 2138; G. Parthasarathy et al., Adv. Mater. 11 (1997), 907), which may be partly doped with lithium (G. Parthasarathy et al., Appl. Phys. Lett. 76 (2000), 2128). On these, a transparent contact layer (generally ITO) is then applied. To be sure, ITO without admixture of lithium or other atoms of the first main group in the electron-injecting layer at the cathode is not well suited to electron injection, thus elevating the operating voltages of such an LED. The admixture of Li or similar atoms, on the other hand, leads to instabilities of the components due to diffusion of the atoms through the organic layers.

The alternative possibility to the transparent cathode consists in inverting the sequence of layers, that is, in constructing the hole-injecting transparent contact (anode) as cover electrode. However, the realization of such inverted structures with the anode on the LED presents considerable difficulties in practice. If the sequence of layers is terminated by the hole-injecting layer, then it is necessary that the usual material for hole injection, indium-tin oxide (or an alternative material), be applied to the organic sequence of layers (e.g. U.S. Pat. No. 5,981,306 (P. Burrows et al.), filed 12 Sep. 1997). This generally requires process technologies of poor compatibility with the organic layers, and sometimes leading to damage.

A decisive disadvantage of the inverted OLED on many non-transparent substrates is the fact that efficient electron injection typically requires materials with very low work of emergence. In the case of uninverted structures, this can sometimes be evaded by introducing interlayers such as LiF (Hung et al. 1997 U.S. Pat. No. 5,677,572, Hung et al., Appl. Phys. Lett. 70 (1997), 152). It has been shown, however, that these interlayers become effective only if the electrode is then vapor-deposited (M. G. Mason, J. Appl. Phys. 89 (2001), 2756). Hence its use is not possible for inverted OLEDs. This holds especially also for inverted structures applied to conductor plates. The usual contact metal (copper, nickel, gold, palladium, tin and aluminum) for conductor plates, owing to their greater work of emergence, do hot allow any efficient electron injection, and/or are unsuitable for charge carrier injection because of the formation of an oxide layer.

Another problem in the realization of organic light-emitting diodes consists in the comparatively great rugosity of conductor plates. This has the result that defects frequently occur, since the organic light-emitting diodes at points of low layer thickness are subject to field peaks and short-circuits. The short-circuit problem could be solved by OLEDs having thick transport layers. But this generally leads to a higher service voltage and reduced efficiency of the OLED.

Another problem in the realization of an organic light-emitting diode or an organic display on a conductor plate is the sealing of the OLED towards the substrate. OLEDs are very sensitive to the standard atmosphere, in particular to oxygen and water. To prevent rapid degradation, a very good seal is indispensable. This is not assured in the case of a conductor plate (permeability rates for water and oxygen of under 10⁻⁴ grams per day per square meter are required).

In the literature, combinations of organic light-emitting diodes and conductor plates on which the driver chips for triggering the OLEDs are located have been proposed. One formulation is that proposed by Chingping Wei et al. (U.S. Pat. No. 5,703,394, 1996; U.S. Pat. No. 5,747,363, 1997, Motorola Inc.), Juang Dar-Chang et al. (U.S. Pat. No. 6,333,603, 2000) and E. Y. Park (U.S. 2002/44441, 2001), in which the substrate on which the OLEDs are produced and the conductor plate on which the electrical components to trigger the OLEDs are located are two separate parts, and these are subsequently connected to each other.

In the patent application by Kusaka Teruo (U.S. Pat. No. 6,201,346, 1998, NEC Corp.), the use of “heat sinks” (that is, elements carrying off heat) on the reverse side of the conductor plate (the OLEDs are located on the front) during production of the OLEDs is proposed. These heat sinks are intended to prevent heating of the OLEDs and of the substrate during the process of production of the OLEDs.

The object of this present invention is to specify a conductor plate with display or light-emitting function on the basis of organic light-emitting diodes, where the emission of light is to take place with high output efficiency and long life (high stability).

According to the invention, this object is accomplished by the features named in claim 1. Advantageous refinements and modifications are the subject of dependent subsidiary claims.

Compatibility of the organic light-emitting diodes is achieved by a suitable novel sequence of layers according to claim 1. For this purpose, a thin highly doped organic interlayer is used, providing for an efficient injection of charge carriers, a layer being preferably employed in the spirit of the invention that forms a morphology with crystalline portions. Then, for smoothing, an organic interlayer of high vitreous transparency may be employed, this in turn being doped for efficient injection and to produce a high conductivity. In the following, the stratification may resemble a conventional (anode on substrate side) or inverted (cathode on substrate side) organic light-emitting diode.

A preferred embodiment for an inverted OLED with doped transport layers and block layers is given for example in German Patent Application DE 101 35 513.0 (2001), X. Zhou et al., Appl. Phys. Lett. 81 (2002), 922. Likewise advantageous is the use of a highly doped protective anode before the transparent anode (or cathode, in normal layer structure) is placed on the component. By doping in the sense of the invention we mean the admixture of organic or inorganic molecules to augment the conductivity of the layer. For that purpose, acceptor-like molecules are employed for p-doping of a hole-transport material, and donor-like molecules are employed for n-doping of the electron transport layer. All this is set forth in full in Patent Application DE 10 13 551.3.

For electrical connection of the individual OLED contacts on one side of the substrate (e.g. conductor plate) to the electronic components mounted on the other side of the substrate (e.g. conductor plate), through contactings are required. These are to be executed in known technology.

Heating of the OLEDs and the substrate does not present a problem in the solution here proposed, since the doped layers are very stable to evolution of heat and well able to carry it off. Hence “heat sinks” as described in U.S. Pat. No. 6,201,346 are not required.

The invention will now be illustrated in more detail in terms of embodiments by way of example, with materials. In the accompanying drawing,

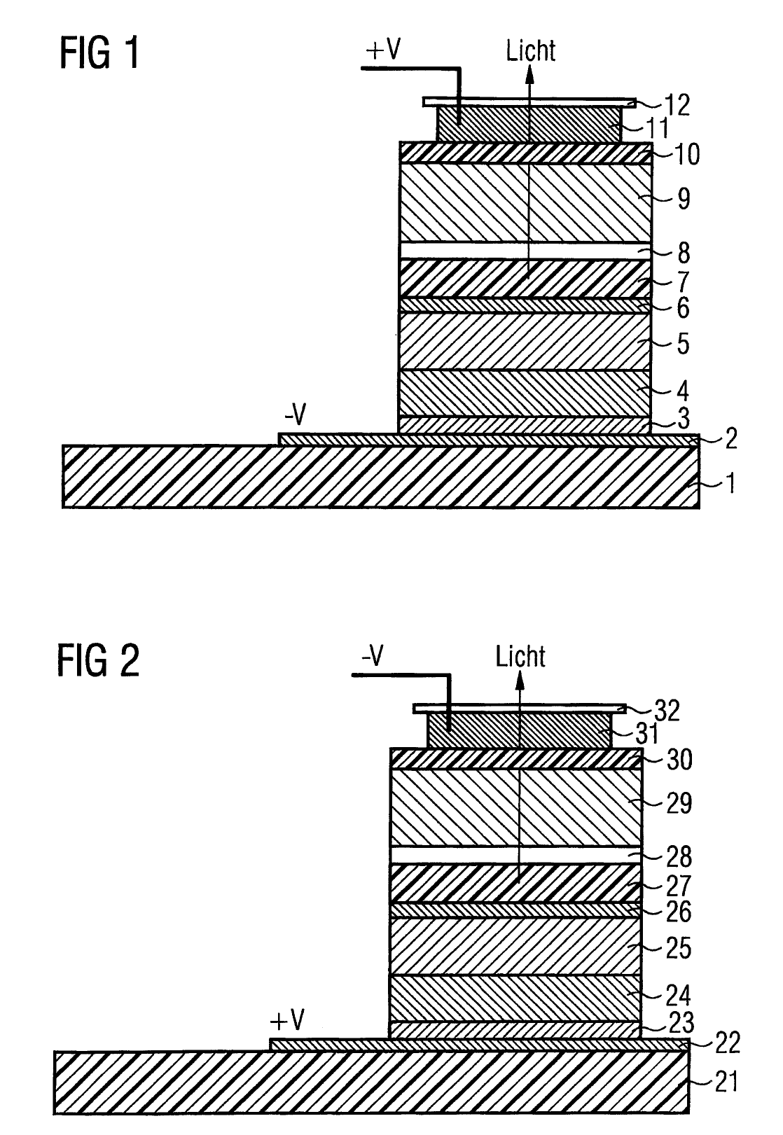

FIG. 1 shows a first embodiment by way of example of a light-emitting apparatus according to the invention with a sequence of layers of an inverted doped OLED, with protective layer;

FIG. 2 shows a second embodiment by way of example of a light-emitting apparatus according to the invention with a structure of an OLED with an anode arranged below on a non-transparent substrate;

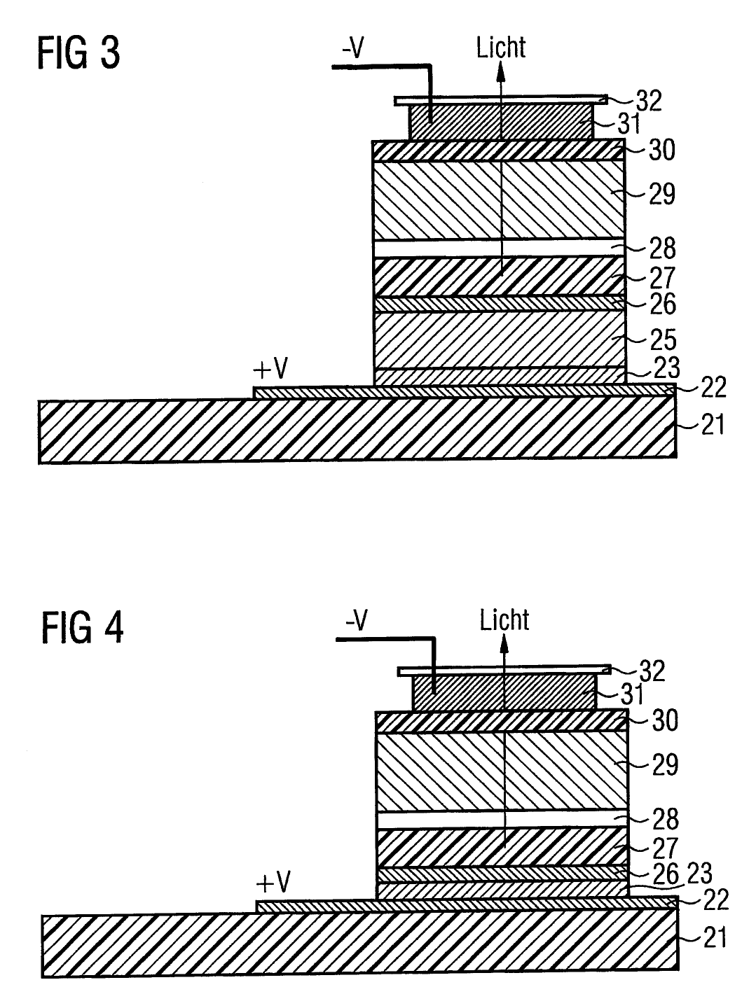

FIG. 3 shows a third embodiment by way of example of a light-emitting apparatus according to the invention as in FIG. 2 with no separate smoothing layer; and

FIG. 4 shows a fourth embodiment by way of example of a light-emitting apparatus according to the invention as in FIG. 2 with a combined hole-injecting and hole-transporting layer.

As represented in FIG. 1, an advantageous embodiment comprises a structure of a representation according to the invention of an organic light-emitting diode (in inverted form) on a conductor plate comprising the following layers, if the conductor plate material as such already exhibits a sufficiently low permeability to oxygen and water, or exhibits the same by other means:
Conductor plate 1
Electrode 2 of a conventional material in conductor plate abrication (cathode=minus pole)
n-doped electron-injecting and transporting layer 3
n-doped smoothing layer 4
n-doped electron transport layer 5
Thinner electron-side block layer 6 of a material whose band ayers match the band layers of the surrounding strata
Hole-side block layer 8 (typically thinner than layer 7) of a material whose band layers match the band layers of the surrounding strata
p-doped hole injecting and transporting layer 9
Protective layer 10 (typically thinner than layer 7), morphology with high crystalline portion, highly p-doped
Protective layer 10 (typically thinner than layer 7), morphology with high crystalline portion, highly p-doped
Protective layer 10 (typically thinner than layer 7), morphology with high crystalline portion, highly p-doped
Electrode 11, hole-injecting (anode=plus pole), preferably transparent
Capsule 12 to exclude environmental influences

An advantageous embodiment of a structure of an OLED according to the invention with the conventional sequence of layers (anode below on non-transparent substrate) is shown in FIG. 2:
Conductor plate 21
Electrode 22 of a conventional material in conductor plate fabrication (anode=plus pole)
p-doped hole-injecting and -transporting layer 23
p-doped smoothing layer 24
p-doped hole-transporting layer 25
Thinner hole-side block layer 26 of a material whose band layers match the band layers of the surrounding strata
Light-emitting layer 27
Electron-side block layer 28 (typically thinner than layer 7) of a material whose band layers match the band layers of the surrounding strata
n-doped electron-injecting and -transporting layer 29
Protective layer 30 (typically thinner than layer 7), morphology with high crystalline portion, highly n-doped
Electrode 31, electron-injecting (cathode=minus pole), preferably transparent
Capsule 32 to exclude environmental influences

It is also in the spirit of the invention for the respective smoothing layer 4 or 24 to be omitted, or consist of a material identical with or similar to the material of the corresponding injecting layer 3 or 23 or of the corresponding transporting layer 5 or 25 and 6 or 26. Such an advantageous embodiment is represented in FIG. 3.
Conductor plate 21
Electrode 22 of a material conventional in conductor plate fabrication (anode=plus pole)
p-doped hole-injecting and -transporting layer 23
p-doped hole transport layer 25
Thinner hole-side block layer 26 of a material whose band layers match the band layers of surrounding layers
Light-emitting layer 27
Electron-side block layer 28 (typically thinner than layer 27) of a material whose band layers match the band layers of the surrounding layers
n-doped electron-injecting and -transporting layer 29
Protective layer 30 (typically thinner than layer 27), morphology with high crystalline portion, highly n-doped
Electrode 31, electron-injecting (cathode=minus pole), preferably transparent
Capsule 32 to exclude environmental influences

An inverted stratification, in that case with two electron-transport layers, is of analogous composition.

Sometimes the hole-injecting layer and the hole-transporting layer may be combined. Such an advantageous embodiment is represented in FIG. 4:
Conductor plate 21
Electrode 22 of a conventional material in conductor plate fabrication (anode=plus pole)
p-doped hole-injecting and -transporting layer 23
Thinner hole-side block layer 26 of a material whose band layers match the band layers of the surrounding strata
Light-emitting layer 27
Electron-side block layer 28 (typically thinner than layer 27) of a material whose band layers match the band layers of the surrounding strata
n-doped electron-injecting and -transporting layer 29
Protective layer 30 (typically thinner than layer 27), morphology with high crystalline portion, highly n-doped
Electrode 31, electron-injecting (cathode minus pole), preferably transparent
Capsule 32 to exclude environmental influences

An inverted layer composition, in that case similarly made up with only one electron transport layer.

Further, it is also in the spirit of the invention if only one side (hole or electron-conducting) is doped. The molar doping concentrations are typically in the range from 1:10 to 1:10,000. If the dopes are substantially smaller than the matrix molecules, in exceptional cases there may be more dopes than matrix molecules in the layer (up to 5:1). The dopes may be organic or inorganic molecules.

In the following, additional embodiments by way of example are given, without drawings.

As a preferred embodiment by way of example, a solution for a composition with inverted sequence of layers will be specified here.

### Fifth Embodiment by Way of Example

41. Substrate (conductor plate)
42. Electrode: copper (cathode)
43. 5 nm Alq3 (aluminum tris-quinolate), doped with cesium 5:1
44. 40 nm bathophenanthrolin (Bphen), doped with cesium 5:1
45. 5 nm BPhen, undoped
47. Electroluminescent and electron-conducting layer: 20 nm Alq₃
48. Hole-side block layer: 5 nm triphenyldiamine (TPD)
49. p-doped layer: 100 nm Starburst 2-TNATA 50:1 doped with F₄-TCNQ
50. Protective layer: 20 nm zinc phthalocyanine, multicrystalline, 50:1 doped with F₄-TCNQ, alternative: 20 nm Pentacen, multicrystalline, 50:1 doped with F₄-TCNQ
51. Transparent electrode (anode): indium-tin oxide (ITO)

Here layer 45 acts as electron-conducting and block layer. In Example 6, the doped electron-conducting layers (43, 44) were doped with a molecular agent (cesium). In the following example, this doping is performed with a molecular agent:

### Sixth Embodiment by Way of Example

41. Substrate (conductor plate)
42. Electrode: copper (cathode
43. 5 nm Alq3 (aluminum tris-quinolate) doped with pyronin B 50:1
44. 40 nm bathophenanthrolin (Bphen), doped with pyronin B 50:1
45. 5 nm Bphen undoped
47. Electroluminescent and electron-conducting layer: 20 nm Alq₃
48. Hole-side block layer; 5 nm triphenyldiamine (TPD)
49. p-doped layer: 100 nm Starburst 2-TNATA 50:1 doped with F₄-TCNQ
50. Protective layer: 20 nm zinc phthalocyanine, multicrystalline, 50:1 doped with F₄-TCNQ, alternative: 20 nm Pentacen, multicrystalline, 50:1 doped with F₄-TCNQ51.
51. Transparent electrode (anode): indium-tin oxide (ITO)

The mixed layers (43, 44, 49, 50) are produced in mixed evaporation by a process of vapor deposition under vacuum. In principle, such layers may be produced by other methods as well, as for example a vapor deposition of the substances one upon another, with ensuing possibly temperature-controlled diffusion of the substances into one another; or by other applications (e.g. centrifuging or printing) of the already mixed substances under vacuum or not. Sometimes, the dope remains to be activated during the process of production or in the layer by suitable physical and/or chemical measures (e.g. light, electric or magnetic fields). The layers (45), (47), (48) were likewise vapor-deposited under vacuum but may alternatively be produced otherwise, e.g. by centrifuging under vacuum or not.

Alternatively, sealing layers may be employed. An example of this is the sealing by means of SiOx layers (silicon oxide), produced by a plasma glazing (CVD process, “chemical vapor deposition”) of SiOx layers having properties comparable to glass, such as colorlessness and transparency. Likewise, nitrous oxide layers (NOx) may be employed, likewise produced by a plasma-supported process.

### List of Reference Numerals

1 conductor plate
2 electrode (cathode=minus pole)
3 n-doped electron-injecting and -transporting layer
4 n-doped smoothing layer
5 n-doped electron transport layer
6 electron-side block layer
7 light-emitting layer
8 hole-side block layer
9 9p-doped hole-injecting and -transporting layer
10 protective layer
11 electrode, hole-injecting (anode=plus pole)
12 capsule
21 conductor plate
22 electrode (anode=plus pole)
23 p-doped hole-injecting and -transporting layer
24 p-doped smoothing layer
25 p-doped hole transport layer
26 hole-side block layer
27 light-emitting layer
28 electron-side block layer
29 n-doped electron-injecting and -transporting layer
30 protective layer
31 electrode (cathode=minus pole)
32 capsule

1. A light-emitting apparatus comprising a conductor plate and a light-emitting component having organic layers, in particular an organic light-emitting diode, consisting of at least one charge carrier transport layer for electrons and/or holes from an organic material and a light-emitting layer of an organic material, wherein the light-emitting component comprises a doped transport layer connected to the contact material of the conductor plate, the doping in the case of a hole transport layer being in the first instance doped acceptor-like to the conductor plate contact material, and in the case of an electron transport layer, in the first instance donor-like to the conductor plate contact material.

2. The apparatus of claim 1, wherein, between the doped injection and transport layers and the contact layer of the conductor plate, one or more additional doped transport layers are applied.

3. The apparatus of claim 1, wherein, between the doped injection and transport layer and the substrate-side transport layer, a doped smoothing layer of a material with high glass temperature is applied.

4. The apparatus of claim 1, wherein only one of the substrate-side injection and transport layer, smoothing layer and substrate-side transport layer is doped, and said doped layer is the thickest of the substrate-side transport layers.

5. The apparatus of claim 1, wherein the molar concentration of the admixure in the doped injection and transport layers, the smoothing layer and the transport layers lies in the range 1:100,000 to 5:1 referred to the ratio of doping molecules to main substance molecules.

6. The apparatus of claim 1, wherein the anode is transparent or semitransparent and provided with a protective layer.

7. The apparatus of claim 1, wherein the contact layer is metallic and semitransparent.

8. The apparatus of claim 1, wherein an additional transparent contact layer for transverse conduction is applied over the semitransparent metal layer.

9. The apparatus of claim 1, wherein the conductor plate is an arbitrary substrate in which the light-emitting components are combined with electric functional components and electrically connected, the electric components not being produced directly on the substrate.
